(19) United States
(12) Patent Application Publication
(10) Pub. No.: US 2008/0118821 A1
(43) Pub. Date: May 22, 2008

(54) Battery pack

(76) Inventors: Todd Marvin Gehring, Hartland, WI (US); Roger Neitzell, Palmyra, WI (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 11/985,059

(22) Filed: Nov. 13, 2007

Related U.S. Application Data
(60) Provisional application No. 60/890,963, filed on Feb. 21, 2007.
(60) Provisional application No. 60/858,647, filed on Nov. 13, 2006.

(51) Int. Cl. H01M 2/20; H01M 10/48

(52) U.S. Cl. 429/92; 429/160; 429/90

(57) ABSTRACT

Systems and methods for electrically connecting components within a battery pack without the use of wires are disclosed. In one embodiment, the invention provides a battery pack that includes a housing and one or more cells positioned inside the housing. Each of the cells includes a positive terminal and a negative terminal that are positioned on a first end of the respective cell. The cells are connected to a connection component that includes one or more slots positioned parallel to the positive terminal and the negative terminal of the respective cell. The connection component connects the cells in a predetermined arrangement.

### RELATED APPLICATIONS

This application claims the benefit of prior filed co-pending U.S. provisional patent application Ser. No. 60/858,647, filed on Nov. 13, 2006, and Ser. No. 60/890,963, filed on Feb. 21, 2007, the entire contents of which are hereby incorporated by reference.

### FIELD OF THE INVENTION

The present invention relates to battery packs.

### BACKGROUND OF THE INVENTION

Battery packs incorporating a plurality of battery cells and electronics (e.g., control circuits, etc.) typically provide the necessary electrical connections between components via wires. Wire connections often complicate the construction of the battery pack and make assembly difficult and time-consuming.

### SUMMARY OF THE INVENTION

Embodiments of the present invention provide a system and method for electrically connecting various components within a battery pack without the use of wires.

In one embodiment, the invention provides a battery pack that includes a housing and one or more cells positioned inside the housing. Each of the cells includes a positive terminal and a negative terminal that are positioned on a first end of a respective cell. Each of the cells is connected to a connection component that includes one or more slots positioned parallel to the positive terminal and the negative terminal of the respective cell. The connection component also includes a plurality of conductive busses positioned adjacent to each slot. A plurality of end traces are positioned on at least one longitudinal end of the conductive busses, and one or more tap connections are positioned on at least one end trace.

In another embodiment, the invention provides a method of wirelessly connecting components in the battery pack. The method includes positioning one or more cells inside a housing. Each of the cells includes a positive terminal and a negative terminal at an angle orthogonal to a respective cell. The method also includes connecting each of the cells to a connection component that includes a plurality of slots positioned parallel to the positive terminal and the negative terminal of the respective cell, as well as placing the positive terminal and the negative terminal of the respective cell in contact with a plurality of conductive busses positioned adjacent to each slot.

Other aspects of the invention will become apparent by consideration of the detailed description and accompanying drawings.

### BRIEF DESCRIPTION OF THE DRAWINGS

FIG. 1 is an exploded view of a portion of a battery pack according to an embodiment of the present invention.

FIG. 2 is several views of the portion of the battery pack shown in FIG. 1.

FIG. 3 is several views of another portion of a battery pack according to an embodiment of the present invention.

FIG. 4 is a partial top view of a portion of a battery pack according to an embodiment of the present invention.

FIG. 5 is another partial top view of a portion of a battery pack according to an embodiment of the present invention.

FIG. 6 is yet another partial top view of a portion of a battery pack according to an embodiment of the present invention.

FIG. 7 is a further partial top view of a portion of a battery pack according to an embodiment of the present invention.

Before at least one embodiment of the invention is explained in detail, it is to be understood that the invention is not limited it its application to the details of the construction and the arrangements of the components set forth in the following description or illustrated in the drawings. The invention is capable of other embodiments and of being practices or carried out in various ways. In addition, it is understood that the phraseology and terminology used herein is for the purpose of description and should not be regarded as limiting.

The use of “including”, “comprising”, or “having” and variations thereof herein is meant to encompass the items listed thereafter and equivalents thereof as well as additional items. Unless limited otherwise, the terms “connected”, “coupled” and variations thereof herein are used broadly to encompass direct and indirect connections and couplings. In addition, the terms “connected” and “coupled” and variations thereof are not restricted to physical or mechanical connections or couplings.

### DETAILED DESCRIPTION

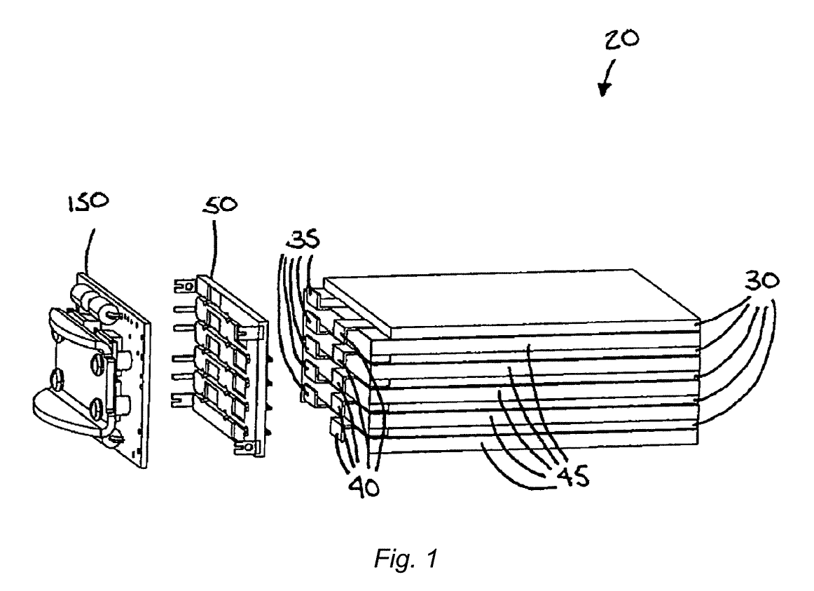

A portion of a battery pack, also referred to as the “core” 20 of the battery pack, is illustrated in FIG. 1. The core 20 is supported and/or enclosed by a housing (not shown) and is configured to power an electrical device (not shown) when the device is connected to the housing. In one construction, the battery pack is configured to power a variety of cordless power tools, such as a circular saw, reciprocating saw, driver drill, impact wrench and the like. In other constructions, the battery pack is configured to power other high-power electrical devices.

As shown in FIG. 1, the core 20 of the battery pack includes a plurality of battery cells 30. In the illustrated construction, the core 20 includes five battery cells 30. In other constructions, the core 20 can include a single battery cell. In further constructions, the core 20 can include more or fewer battery cells than shown and described. In the illustrated construction, the battery cells 30 are configured as prismatic cells having a lithium-based chemistry. The battery cells 30 also have a nominal voltage of approximately 4.0-volts and a capacity of approximately 1.5-ampere hours. In other constructions, the battery cells 30 can have a different chemistry, nominal voltage and/or capacity rating than the battery cells 30 shown and described.

Each battery cell 30 also includes a positive terminal 35 and a negative terminal 40. The battery cells 30 included in the core 20 of the battery pack are also stacked one on top of the other. In some constructions, such as the construction shown in FIG. 1, a foam pad 45 is positioned in between the plurality of stacked battery cells 30. In other constructions, another component is positioned in between the cells 30 in order to separate the cells 30 or to provide some cushioning for the core 20. For example, double-sided tape (not shown) can be positioned between the cells 30 to keep the cells 30 from moving with respect to the other cells.

As shown in FIG. 1, the core 20 also includes a connection component 50. The connection component 50 provides the necessary connections between the battery cells 30. That is, the connection component 50 connects the cells 30 in the desired arrangement (e.g., a parallel arrangement, a serial arrangement, a combination thereof, etc.).

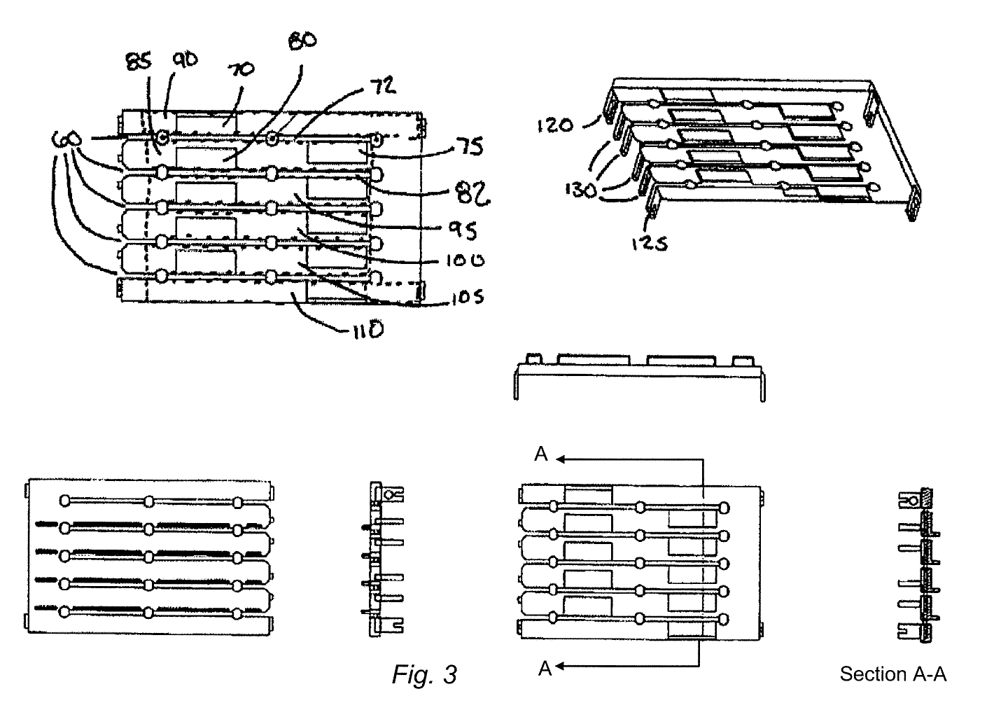

In the construction shown, the connection component 50 includes various slots 60 (shown in FIG. 3) for receiving the various terminals 35, 40 of the battery cells 30. The connection component 50 also includes a plurality of conductive traces for electrically connecting certain battery terminals to others. The slots 60 separate the traces from each other. For example, in the construction shown in FIG. 3, the connection component 50 includes a first exposed conductive trace portion 70 positioned above the first slot 72, a second exposed conductive trace portion 75 positioned below the first slot 72 and a third exposed conductive trace portion 80 positioned above a second slot 82. The positive terminal 35 of the first battery cell 30 is inserted through the slot 72 and is bent (as shown in FIG. 1) until the terminal 35 is electrically connected to the first exposed conductive trace portion 70. The negative terminal 40 of the first battery cell 30 is also inserted through the slot 72 and is bent in the opposite direction as the positive terminal 35 until the negative terminal 40 is electrically connected to the second exposed conductive trace portion 75. The positive terminal 35 of the second battery cell 30 is inserted through the second slot 82 and is bent (as shown in FIG. 1) until the terminal 35 is electrically connected to the third exposed conductive trace portion 80.

As shown in FIG. 3, the second exposed conductive trace portion 75 and the third exposed conductive trace portion 80 are both located below the first slot 72 and above the second slot 82. These exposed trace portions 75, 80 are both portions of the same trace 85 (shown in FIG. 3 in dashed lines). In addition to conductive trace 85, the connection component 50 also includes conductive traces 90, 95, 100, 105 and 110. In this example, the traces 85-110 and exposed trace portions are arranged such that the battery cells 30 are arranged in series (i.e., a serial arrangement). The terminals 35, 40 can be electrically connected to traces 85-110 via soldering, welding or a variation thereof.

In the illustrated construction, the connection component 50 also includes a first power connection 120 and a second power connection 125. The first power connection 120 is also referred to as the positive power connection and the second power connection 125 is also referred to as the negative power connection. The positive and negative power connections 120, 125 are used to transfer power from the serially-connected battery cells 30.

In the illustrated construction, the connection component 50 also includes a plurality of tapping connections 130. The tapping connections 130 are electrically connected to the conductive traces 85-110 and can be used to “tap” the positive terminal 35 of the cell 30 connected to that particular trace to determine the state of charge for that cell 30. In some constructions, the power connections 120, 125 and the tapping connections 130 are extended portions of the conductive traces 85-110. In other constructions, the power connections 120, 125 and the tapping connections 130 are separate elements that are electrically connected to the traces 85-110 via soldering, welding or a variation thereof.

In one construction, the connection component 50 is an insert molded component. In other constructions, the connection component 50 is a printed circuit board.

As shown in FIG. 1, the core 20 also includes a control circuit component 150. The control circuit component 150 includes a microcontroller used to monitor and control the parameters and operation of the battery pack. The control circuit component 150 can also include the battery pack terminals (not shown) that are used for transferring power from the battery pack to the electrical device. In the construction shown, the control circuit component 150 is a printed circuit board.

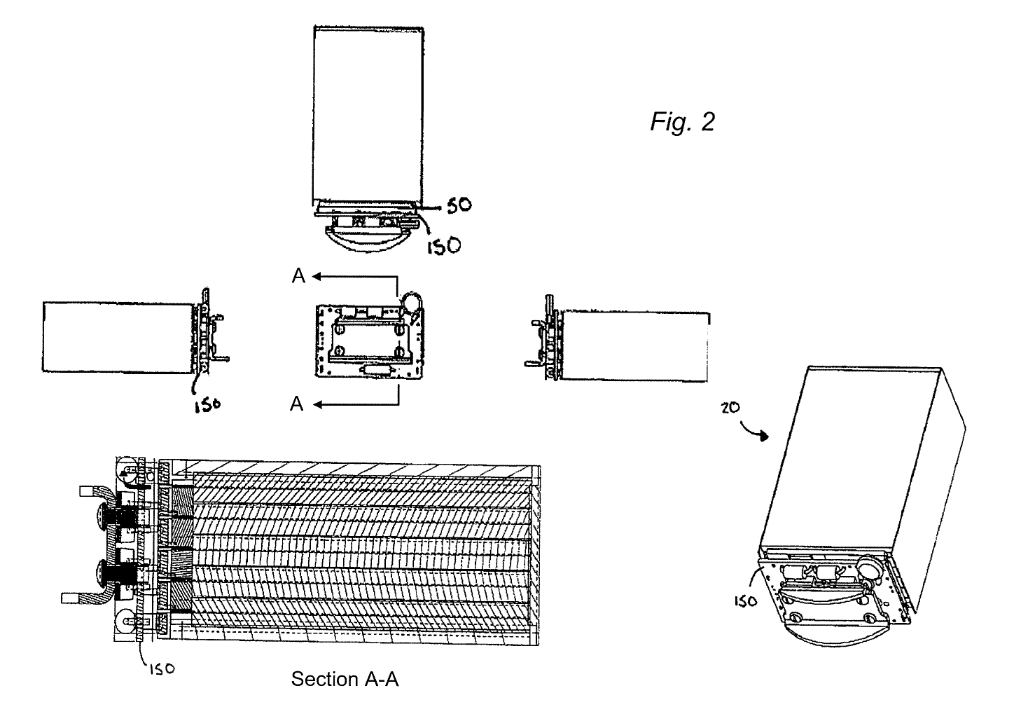

As shown in FIGS. 1 and 2, the connection component 50 is electrically connected to the control circuit component 150 via the power connections 120, 125 and the tapping connections 130. For example, connectors may include pins or leads (e.g. filler leads or power leads). In the illustrated construction, the connections between the two components 50, 150 are achieved in a wireless manner. As shown, the control circuit component 150 is parallel to the connection component 50. In other constructions, the control circuit component 150 can be positioned normal to the connection component 50 or at another angle or orientation. The power connections 120, 125 and the tapping connections 130 would have to be configured to accommodate the new position and location of the control circuit component 150. That is, the connections 120-130 would have to change shape and length in order to provide the wireless connection between the two components 50, 150.

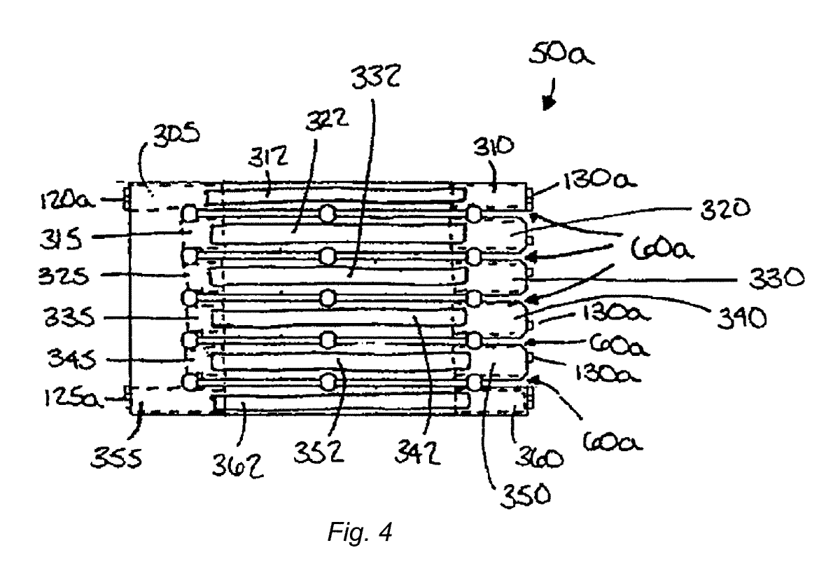

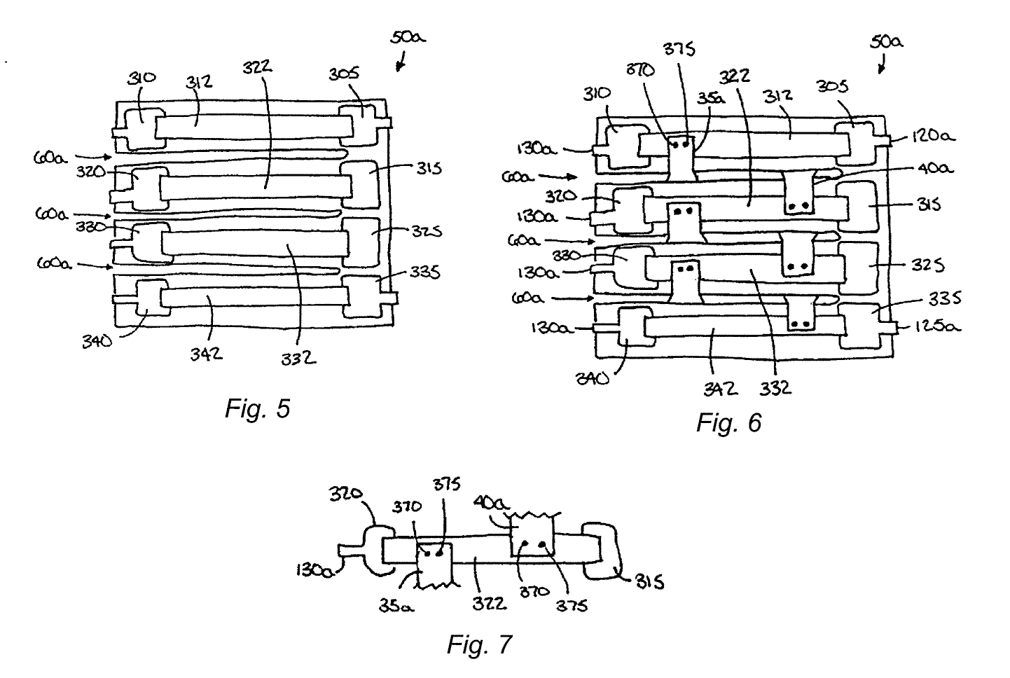

Another construction of the connection component 50, designated as the connection component 50a, is shown, at least partially, in FIGS. 4-7. Common elements are identified by the same reference number followed by “a”.

In lieu of the conductive traces 85-110 shown in FIG. 3 via dotted lines, the connection component 50a includes first conductive end traces and second conductive end traces coupled via a conductive buss bar. For example, the connection component 50a includes a first conductive end trace 305 and a second conductive end trace 310 (both shown in dotted lines in FIG. 4). The conductive end traces 305 and 310 are connected via a conductive buss bar 312. In one construction, the conductive buss bar 312 is a copper bar, and the copper bar 312 is soldered to the conductive end traces 305 and 310 of the connection component 50a. In other constructions, other conductive materials can be used for the conductive buss bar 312, and other methods of connecting the buss bar 312 to the conductive end traces 305 and 310 can be used. For example, the conductive buss bar 321 can be a bar formed from another conductive material such as brass, and can be connected to the conductive end traces by soldering or welding, for example.

As shown in FIGS. 4-6, the remaining first conductive end traces are labeled as end traces 315, 325, 335, 345 and 355, the remaining second conductive end traces are labeled as end traces 320, 330, 340, 350 and 360, and the remaining conductive buss bars are labeled as buss bars 322, 332, 342, 352 and 362. As shown, the first conductive end trace 315 is coupled to the second conductive end trace 320 via conductive buss bar 322. The remaining buss bars and end traces are connected in a similar manner. As shown in FIGS. 4-6, slots 60a separate the first conductive end traces 305-355, the second conductive end traces 310-360 and ultimately the conductive buss bars 312-362 from the other first conductive end traces, second conductive end traces and conductive buss bars.

As shown in FIG. 6, the positive terminals 35a and the negative terminals 40a of the battery cells 30 (shown in FIG. 1) are positioned in a similar manner as shown in the previous FIGS. 1-3. The positive terminals 35a and the negative terminals 40a of the battery cells 30 are welded to the conductive buss bars 312-362. For example, the terminals can be ultra-sonically welded, spot welded and/or resistance welded. As shown in FIG. 6, each terminal 35a, 40a of the battery cells 30 include a first weld spot 370 and a second weld spot 375. In other constructions, the terminals of the battery cells 30 can be welded to the buss bars with more or fewer weld spots 370, 375 than shown and described.

Although the invention has been described in detail with reference to certain preferred embodiments, variations and modifications exist within the scope and spirit of one or more independent aspects of the invention as described.

Thus, the invention provides, among other things, a system and method for electrically connecting various components within a battery pack without the use of wires. Various features and advantages of the invention are set forth in the following claims.

What is claimed is:

1. A battery pack, comprising:
a housing;
one or more cells positioned inside the housing, each of the cells including a positive terminal and a negative terminal positioned on a first end of a respective cell; and
a connection component, the connection component including one or more slots, wherein each slot is positioned parallel to the positive terminal and the negative terminal of the respective cell, the connection component connecting the cells in a predetermined arrangement, the connection component further including
a plurality of conductive busses, the conductive busses positioned adjacent to each slot,
a plurality of end traces, the end traces positioned on at least one longitudinal end of the conductive busses,
one or more tap connections, the tap connections positioned on at least one end trace, and
a positive power terminal and a negative power terminal each connected to a respective conductive buss among the plurality of conductive busses.

2. The battery pack of claim 1, further comprising a control circuit component connected to the connection component and positioned parallel to the connection component.

3. The battery pack of claim 2, wherein the control circuit component is configured to control a set of operational parameters.

4. The battery pack of claim 2, wherein the control circuit component is configured to monitor a set of operational parameters.

5. The battery pack of claim 2, wherein the control circuit component includes a microcontroller configured to monitor the tap connections.

6. The battery pack of claim 5, wherein the microcontroller is configured to monitor a state of charge of each of the cells via the tap connections.

7. The battery pack of claim 2, wherein the control circuit component includes a microcontroller configured to monitor the power terminals of the connection component.

8. The battery pack of claim 7, wherein the microcontroller is configured to monitor a state of charge of the battery pack via the power terminals.

9. The battery pack of claim 2, wherein the control circuit component is mounted to the connection component via leads.

10. The battery pack of claim 1, wherein the positive terminal and the negative terminal are bent to an angle orthogonal to the cells.

11. The battery pack of claim 1, wherein the cells are prismatic cells.

12. The battery pack of claim 1, wherein the cells are composed of a lithium-based chemistry.

13. The battery pack of claim 1, wherein the arrangement is a serial arrangement.

14. The battery pack of claim 1, wherein the arrangement is a parallel arrangement.

15. The battery pack of claim 1, wherein the arrangement is a combination serial and parallel arrangement.

16. The battery pack of claim 1, wherein the positive and negative terminals of each cell are welded to respective conductive busses.

17. A battery pack, comprising:
a housing;
a plurality of cells positioned inside the housing, each of the cells including a positive terminal and a negative terminal;
a connection component, the connection component including one or more slots, wherein the connection component connects the cells in a predetermined arrangement, the connection component further including a positive power terminal and a negative power terminal connected to the plurality of cells; and
a control circuit component connected to the connection component, the control circuit component including a microcontroller.

18. The battery pack of claim 17, wherein the positive terminal and the negative terminal are positioned on a first end of a respective cell.

19. The battery pack of claim 17, further comprising one or more tap connections, wherein each tap connection is connected to the control circuit component.

20. The battery pack of claim 19, wherein the control circuit component includes a microcontroller configured to monitor the tap connections.

21. The battery pack of claim 20, wherein the microcontroller is configured to monitor a state of charge of each of the cells via the tap connections.

22. The battery pack of claim 17, wherein the control circuit component includes a microcontroller configured to monitor the power terminals of the connection component.

23. The battery pack of claim 22, wherein the microcontroller is configured to monitor a state of charge of the battery pack via the power terminals.

24. The battery pack of claim 17, wherein the control circuit component is mounted to the connection component via leads.

25. The battery pack of claim 17, wherein the cells are prismatic cells.

26. The battery pack of claim 17, wherein the cells are composed of a lithium-based chemistry.

27. The battery pack of claim 17, wherein the arrangement is a serial arrangement.

28. The battery pack of claim 17, wherein the arrangement is a parallel arrangement.

29. The battery pack of claim 17, wherein the arrangement is a combination serial and parallel arrangement.

30. The battery pack of claim 17, further comprising
a plurality of end traces; and
a plurality of conductive busses, wherein the end traces are positioned on at least one longitudinal end of the conductive busses.
